(19) United States
(12) Patent Application Publication
(10) Pub. No.: US 2011/0042968 A1
(43) Pub. Date: Feb. 24, 2011

(54) METHOD AND PLANT FOR COMBINED PRODUCTION OF ELECTRIC ENERGY AND WATER

(75) Inventor: Inge Tronstad, Asker (NO)

Correspondence Address: BIRCH STEWART KOLASCH & BIRCH, PO BOX 747, FALLS CHURCH, VA, 22040-0747, US

(73) Assignee: Nebb Technology AS, Asker (NO)

(21) Appl. No.: 12/666,746

(22) PCT Filed: May 23, 2008
(86) PCT No.: PCT/NO08/00179

§ 371 Date: Dec. 24, 2009

Related U.S. Application Data
(60) Provisional application No. 60/929,441, filed on Jun. 27, 2007.

(51) Int. Cl. F02C 3/20; F02C 6/00

(52) U.S. Cl. 290/1 R; 60/784

(57) ABSTRACT

This invention relates to a method and plant for combined electric energy and water production, where the method comprises feeding substantially pure oxygen and a hydrocarbon fuel in a stochiometric ratio to a combustor (5), combusting the oxygen and hydrocarbon feed for forming an exhaust gas at comparatively high temperature and pressure, passing the exhaust gas at high temperature and pressure to an expander (7) that runs an electric generator (8) and an exhaust gas compressor (9), passing the exhaust gass exiting the expander to an exhaust gas cooler (11) which cools the gas to a temperature above the steam condensation temperature, passing the exhaust gas exiting the exhaust gas cooler to the exhaust gas compressor for pressurising, and passing the pressurised exhaust gas to an exhaust gas condenser (14) where the exhaust gas is condensed and thus separated into a substantially pure water fraction and a gaseous CO.

### BACKGROUND

A sufficient and reliable fresh water supply is a necessity for a self-sustainable development. But for many regions of the world, access to fresh water is presently a growing concern. This is especially the case for supply of fresh water suitable as drinking water, which has become a shortage in some regions. Another important necessity for self-sustainable development is access to clean energy, such as electric power.

Many dry regions of the world have access to natural gas or oil. Stochiometric combustion of hydrocarbons produces H₂O and CO₂. This opens for a combined solution of producing both electric power and water in thermal power plants which combusts hydrocarbons.

However, the present concern about global warming due to emissions of green house gases makes it advantageous/necessary to address the problem with CO₂-emissions when combusting fossil hydrocarbons.

### PRIOR ART

Clean Energy Systems Inc. has suggested building power plants based on combustion of a pure carbonaceous fuel in the presence of pure oxygen and water, resulting in the production of a high-energy gas at high temperature and pressure consisting of only water and CO₂ in a type of gas generator called an oxy-fuel generator. The thermal and mechanical energy in this gas can be utilised to produce, for example, electrical energy in conventional steam-driven multistage turbines. After the useful energy in the gas from the oxy-fuel generator is converted to electrical energy, the relatively cold gas mixture of steam and CO₂ can easily be separated by cooling until the steam is condensed into liquid water. The resulting gas phase consists of pure CO₂ which is ready for pressurisation and depositing.

This technology is described in detail in and protected by a number of patents. See, for example, U.S. Pat. No. 5,724,805, U.S. Pat. No. 5,956,937, U.S. Pat. No. 6,389,814, U.S. Pat. No. 6,598,398, or WO 2005/100754.

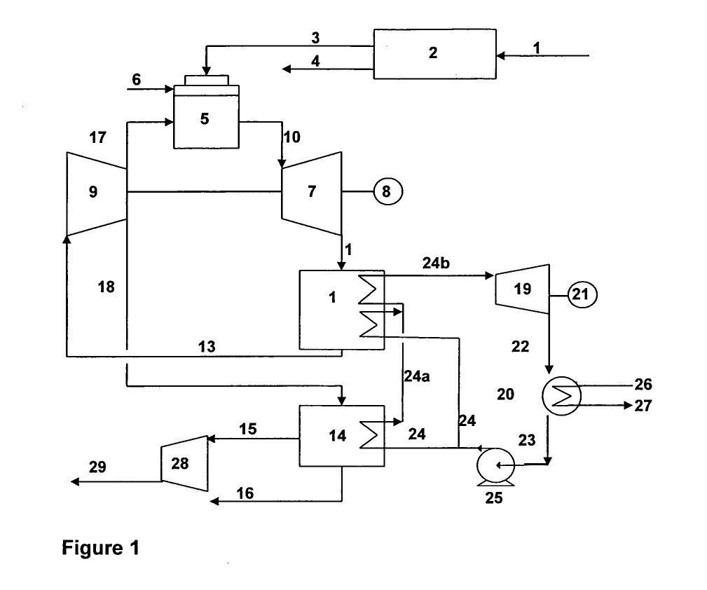

DE 103 30 859 discloses a plant, see FIGS. 1-4, comprising an oxygen supply 9 delivering pure oxygen to an oxy-fuel combustor 2. Fuel is delivered to the combustor through line 20. The combustion gases leaving combustor 2 are sent to a turbine 3 which drives a generator 8 and compressor 1. Then the combustion gases are sent to a cooler 4 for extraction of residual thermal energy of the gases, by use of turbine 10 and generator 11 in cooling medium circuit 24-30. After passing through cooler 4, the combustion gases are passed to the compressor 1, and separated into a fraction being passed into combustor 2 and one fraction being passed to condenser 7a, 7b for separating the CO₂ and water content of the combustion gas fraction.

EP 1 219 800 discloses a plant employing an oxy-fuel combustor 2 forming a combustion gas which is passed to a turbine 7 driving a generator 5 and compressor 18. D2 employs the CO₂-fraction of the combustion gases as the working medium, such that after passing through turbine 7, the combustion gases are cooled by heat exchangers 11 and 13 before being passed to compressor 18. Then the gases are cooled in heat exchanger 14 to form a liquid phase of water which may be drawn off and the CO₂ fraction is passed into condenser 4 to form liquid CO₂. The liquid CO₂, is heated by passing through heat exchanger 11 and then passed through turbine 22 for extraction of thermal energy before being passed into combustor 2.

EP 0 831 205 discloses a plant comprising an oxy-fuel combustor 1 providing combustion gases driving a power generating mean 9 which may be a turbine driving a generator, and where the combustion gases are then being passed to a condenser for separation of the CO₂ and the water.

There is however a problem in that carbon capture and sequestration from exhaust gases from thermal power plants requires substantial amounts of energy, and thus becomes relatively costly. It is therefore a need for more energy efficient thermal power plants with carbon capture and sequestration.

### OBJECT OF THE INVENTION

The main objective of this invention is to provide an improved method and plant for combined production of electricity and water and which captures the produced CO₂.

A further objective is to obtain an energy efficient method and plant for combined production of electricity and water and which captures the produced CO₂.

The objective of the invention may be obtained by the features as set forth in the following description of the invention and/or the appended claims.

### DESCRIPTION OF THE INVENTION

The invention is based on the realization that by pressurising the exhaust gas before condensation, the heat of vaporisation is reduced such that a higher condensation temperature may be employed, which again allows exploiting more of the heat content of the exhaust gas by providing a cooling medium with a higher exergy.

Thus in a first aspect, the invention relates to a method for combined production of water and electric energy, comprising:
feeding substantially pure oxygen and a hydrocarbon fuel in a stochiometric ratio to a combustor,
combusting the oxygen and hydrocarbon feed for forming an exhaust gas at comparatively high temperature and pressure,
passing the exhaust gas at high temperature and pressure to an expander that runs an electric generator and an exhaust gas compressor,
passing the exhaust gas exiting the expander to an exhaust gas cooler which cools the gas to a temperature above the steam condensation temperature,
passing the exhaust gas exiting the exhaust gas cooler to the exhaust gas compressor for pressurising, and
passing the pressurised exhaust gas to an exhaust gas condenser where the exhaust gas is condensed and thus separated into a substantially pure water fraction and a gaseous CO₂-fraction.

The term “substantially pure oxygen” as used herein means as pure as possible oxygen gas or liquid oxygen to be used as oxygen feed to the combustor. The method according to the invention will function with more or less enriched oxygen phases as oxygen supply to the combustor, but it is advantageous that the oxygen supply is as pure an oxygen phase as possible in order to avoid formation of unwanted combustion products in the exhaust gas, such as for instance NOₓ etc. The same applies for the hydrocarbon feed. The invention will function with any type hydrocarbon feed of various purity grades, but it is advantageous to employ a pure as possible hydrocarbon in order to form only water and carbon dioxide in the combustion process, and thus avoid the need for gas scrubbers, gas cyclones and other conventional exhaust cleaning measures associated with thermal power plants based on combustion of carbonaceous fuels.

The oxygen supply may advantageously be obtained by use of an air separation unit. By “air separating unit” we mean any unit or device able to separate atmospheric air into a substantially pure oxygen fraction and a residual fraction. This unit may be a cryogenic air separation unit or non-cryogenic air separation processes such as pressure swing adsorption, vacuum-pressure swing adsorption, or membrane separation. However, the invention may apply any present and future conceivable air separation unit able to provide a sufficient oxygen supply needed to run the combustion process a stochiometric conditions. The air separation unit may advantageously be able to separate the residual fraction into a substantially pure liquid nitrogen fraction, and possibly also substantially pure fractions of the noble gases present in atmospheric air. This will give the process according to the invention an improved economy by providing more products for sale.

The feature of passing the exhaust gas exiting the exhaust gas cooler to an exhaust gas compressor for pressurising before condensation of the water content in the exhaust gas condenser provides several advantages.

One advantage is that the condensation takes place at a higher temperature (due to the increased pressure), and thus allows extraction of energy to the cooling medium flowing in the exhaust gas condenser and the exhaust gas cooler at a higher level (higher exergy). This higher exergy more than compensates for the energy consumption used to compress the exhaust gas before condensation, such that the overall efficiency increases. This may be seen by a comparison calculation of the electric energy which may be extracted by placing a secondary steam turbine with generator in the cooling medium circuit in case of pressurised condensation and by conventional non-pressurised condensation. In both examples, the following assumptions are made: The exhaust extracted from the compressor in the primary gas turbine train will be at 500 ° C., 60 bar and have about 50 mol % H₂O and 50 mol % CO₂. The polytrophic energy efficiency of the secondary steam turbine including electric generator is assumed to be 80%, the remaining water content in the exhaust gas after condensation is 4% and the temperature of the exhaust gas after condensation/recompression is 114° C. at 60 bar. In both calculations, the mass flow is set to 1 kg/s. Then; if the exhaust gas is cooled directly from the primary expander at a pressure of 60 bar and all exergy of the cooling medium of the condenser is exploited in a second steam turbine to produce electric energy, it may be obtained 366 kW. Alternatively, if the exhaust gas leaving the primary steam turbine (500° C., 60 bar) are allowed to be expanded to one bar before condensation of the water (followed by compressing the CO₂-phase after condensation to 60 bar and then cool it to 114° C. in order to make similar exit conditions as in the comparison example), the net electric energy from the process (cooling circuit expander+exhaust gas expander−CO₂ compressor) becomes 313 kW. Thus, condensation at 60 bar makes it possible to extract 17% more electricity from the condensation process as compared with condensing the exhaust gas at atmospheric pressure.

Another advantage of pressurised condensation is that the gas flow volumes downstream of the exhaust gas extraction will be significantly lower, since the volume flow of a gaseous medium is inversely proportional to the pressure of the gas. This allows use of process equipment with a comparably smaller cross sectional area. Also, the relatively higher temperature of the compressed exhaust gas is beneficial in that it allows use of a higher temperature difference (pinch temperature) in the heat exchanger, and thus allows use of heat exchangers with smaller dimensions.

Another advantage of pressurising the exhaust gas is that it gives a compressed CO₂-phase after the condensation, which results in a similar reduction in the need for further compression equipment and energy consumption before end-use or sequestration of the CO₂-gas. For example, it may allow skipping use of one or more compressors in the export line for the CO₂-gas. Also, the compressed condensation gives an advantage in that the CO₂-phase becomes drier, this may be important in further applications of the CO₂-gas. For example, at 30° C., a condensation at atmospheric pressure will leave about 4% water in the gas phase, while at 60 bar the water residue is only 0.07%.

The combustion process may advantageously be controlled/cooled by insertion of water and/or recycled CO₂/steam from the compressor. In this embodiment, the invention will comprise passing a part stream from the exhaust gas compressor to the combustor and/or passing water from the water outlet line from the exhaust gas condenser to the combustor.

In a second aspect, the method according to the invention may include dividing the exhaust gas compression in two stages and placing an intercooler for partial condensation of the water content of the exhaust gas in-between the first and second exhaust gas compressor. This embodiment obtains a reduction in the total work compression due to reduced mass flow in the downstream compressor. Also, the intermediate cooling/condensation opens for the possibility of regulating the CO₂/H₂O-ratio of the gas being recycled into the combustor. This feature allows a better stability and control of the composition of the exhaust gas being recycled to the combustion chamber, and thus reduces the possibility for off-design operation of the combustion process. This allows optimising the energy economy of the power plant since the extraction rate of water and heating (due to compression work) of the exhaust gas may be optimised due to the energy need for compression and recovery of the thermal energy of the exhaust gas.

The term “combustor” as used herein means any type of chemical reactor able to sustain a continuous combustion of a hydrocarbon feed in a pure oxygen atmosphere.

The term “expander” as used herein means any device which may extract energy from the high temperature and high pressure exhaust gas and convert it to mechanical energy. This may advantageously be multistage turbines, but the invention is not bound to this choice. Any presently and future conceivable device for extracting the energy content of the exhaust gas and convert it to mechanical energy may be employed.

In a third aspect the invention relates to a plant for combined production of water and electric energy, comprising:
a source for pure oxygen,
a source for a hydrocarbon fuel,
a combustor being fed with the pure oxygen and the hydrocarbon fuel,
an expander running an electric generator and a gas compressor,
means for passing the exhaust gas exiting the combustor to the expander,
an exhaust gas cooler,
means for passing the exhaust gas exiting the expander to the exhaust gas cooler,
means for transporting the exhaust gas exiting the exhaust gas cooler to the compressor,
an exhaust gas condenser,
means for passing the pressurised exhaust gas exiting the compressor to the exhaust gas condenser,
means for supplying a cooling medium to the exhaust gas condenser and the exhaust gas cooler, and
means for separate retrieval of the gaseous CO₂-fraction and the water fraction from the exhaust gas condenser, respectively.

In addition to the above given means and process equipment, the plant may optionally also comprise means for extraction of the heat content in the cooling medium supplied to the exhaust gas cooler and the exhaust gas condenser and convert the energy to electric energy. These means may i.e. be an expander in the cooling circuit running a second electric generator in order to exploit the exergy of the cooling medium. The cooling circuit may advantageously be divided into a low temperature part for supplying cooling medium to the exhaust gas condenser and first heat exchanger of the exhaust gas cooler, a mediate high temperature part supplying intermediate heated cooling medium to a second heat exchanger upstream of the first heat exchanger in the exhaust gas cooler, and a high temperature part supplying maximum heated cooling medium to the cooling circuit expander.

The combustion process in the combustor may advantageously be controlled/cooled by insertion of water and/or recycled CO₂/steam from the compressor. In this embodiment, the plant will additionally comprise means for passing the exhaust gas from the exhaust gas compressor to the combustor and/or means for passing water from the water outlet line from the exhaust gas condenser to the combustor.

Continuous operation of the invention requires access to a thermal sink in order to obtain cooling/condensation of the exhaust gas. The availability of cooling water determines which sink being employed. In case of access to cooling water, the heat sink may be a heat exchanger (20) supplied with external cold water (26). However, in lack of a sufficient supply of cooling water, one may use i.e. a cooling tower.

As an alternative to convert the heat energy of the exhaust gas to electric energy, one or both of the electric generators (8, 21) may be omitted and the corresponding expander(s), (7) and (19), respectively may be used to provide mechanical energy.

The invention has the advantage that it allows simultaneous production of electric energy and water in an environmental friendly manner. Formation of NOₓ is practically eliminated since the combustion process takes place in a substantially pure oxygen atmosphere or alternatively with addition of some water and CO₂. The only nitrogen supplied to the combustion zone is eventual nitrogen-containing pollutants in the hydrocarbon feed. The same applies for eventual other known pollutants such as sulphur compounds etc. An additional environmental advantage is that the process gives a substantially pure fraction of CO₂. This makes it relatively easy to compress or treat the CO₂-gas for sequestering and/or for sale to industrial purposes. The method according to the first aspect of the invention provides substantially pure and separate CO₂ and water products. The CO₂ fraction may be offered on the market for sale or it may be transported to a salt aquifer, earth formation etc. for sequestering.

### EMBODIMENTS OF THE INVENTION

The invention will be described in greater detail by way of examples of embodiments of the invention. These examples should not be interpreted as a limitation of the general inventive concept of simultaneous production of electric energy and water by stochiometric combustion of hydrocarbons in a pure oxygen atmosphere and subsequent pressurised condensation of the exhaust gas.

### Example Embodiment 1

This embodiment is a plant with access to cooling water such that the necessary regeneration of the cooling medium may simply be obtained by passing the cooling medium through a heat exchanger and exchange the added heat content of the cooling medium to the cooling water. The embodiment employs a second expander and electric generator to convert the energy of the cooling medium to electric power, this production will be denoted the secondary electricity production. Further, the embodiment employs an air separation unit for oxygen supply and a multi-stage gas turbine as expanders, both in the primary and secondary electricity productions.

The example embodiment is shown schematically in FIG. 1, and comprises:
an air supply line 1 in communication with an air separating unit 2 for separating the air supply into an oxygen fraction and a residual fraction,
a combustor 5,
means 3 for feeding the oxygen fraction to the combustor 5,
means 4 for extracting the residual fraction from the air separating unit 2,
means for passing a hydrocarbon supply 6 in a stochiometric ratio of the oxygen feed 3 to the combustor 5,
an expander 7 running a generator 8 and a compressor 9,
means 10 for passing the exhaust gas exiting the combustor 5 to the expander 7,
means 17 for passing a fraction of pressurised exhaust gas from compressor 9 to the combustor 5,
an exhaust gas cooler 11,
means 12 for passing the exhaust gas exiting the expander 7 to the exhaust gas cooler 11,
means 13 for passing the exhaust gas exiting the exhaust gas cooler 11 to the compressor 9,
an exhaust gas condenser 14,
means 18 for passing the pressurised exhaust gas exiting the compressor 9 to the exhaust gas condenser 14,
means 16 for extraction of produced water from the exhaust gas condenser 14,
means 15, 28, 29 for extraction and further compression of CO₂ from the exhaust gas condenser 14,

and a cooling circuit comprising:
low temperature pipeline 24 with pump 25 passing regenerated cooling medium from the pump 25 to the exhaust gas condenser 14 and the exhaust gas cooler 11,
pipeline 24a passing medium heated cooling medium from the exhaust gas condenser 14 to the exhaust gas cooler 11,
cooling circuit expander 19,
pipeline 24b passing highly heated cooling medium from the exhaust gas cooler 11 to the cooling circuit expander 19,
generator 21 for production of electric energy,
heat exchanger 20 in communication with a source for cooling water 26, 27,
pipeline 22 passing cooling medium from the cooling circuit expander 19 to the heat exchanger 20, and
pipeline 23 passing regenerated cooling medium to pump 25.

The plant according to this embodiment operates as follows, air is sucked into air separating unit 2 and separated to a pure oxygen fraction and a residual fraction comprising substantially nitrogen gas and noble gases. The pure oxygen fraction is transported into the combustor 5 in a stochiometric ratio of a hydrocarbon feed. The combustion process is controlled by recycling some of the exhaust gas (comprising substantially CO₂ and H₂O) through pipeline 17. The exhaust gas exiting the combustor 5 will typically have a temperature of 1000 to 1500° C. and a pressure from about 30 to 60 bar, depending on the heat tolerance of the turbine being used as expander 7. After passing through the expander 7, the exhaust gas will typically be at about 500° C. and 1 bar. This part of the plant may be considered as the primary electricity production.

The heat content of the exhaust gas is then extracted by use of heat exchanging with the cooling medium in exhaust gas cooler 11, in this example embodiment there is employed two heat exchangers working in series such that after passing through the first heat exchanger the exhaust gas is cooled to about 400° C. and a pressure of about 1 bar, and after passing through the second heat exchanger the exhaust gas is cooled to about 100° C. and a pressure of about 1 bar. The cooling medium exiting the second heat exchanger of the exhaust gas cooler 11 have a temperature of about 450° C. and a pressure of about 45 bar.

The exhaust gas exiting the cooler 11 is sent to exhaust gas compressor 9 where it is compressed to a pressure of 60 bar and a temperature of about 400° C. A fraction of the compressed exhaust gas is injected into the combustor for regulating the combustion process, while the residual fraction of the compressed exhaust gas, is sent to the exhaust gas condenser 14 for separation of the exhaust gas to a liquid water fraction and CO₂-gas phase. The condensation is obtained by cooling the compressed exhaust gas to about 50° C. by heat exchanging the exhaust gas with a cooling medium in the condenser. The cooling medium enters the condenser heat exchanger at a temperature of about 20° C. and exits at about 150° C., and is then passed to the second heat exchanger of the exhaust gas cooler 11.

As mentioned, the cooling medium exiting the exhaust gas cooler 11 has a temperature of about 450° C. and a pressure of about 45 bar. The heated cooling medium is passed through an expander 19 in the form of a multi stage gas turbine, where it is cooled and expanded to a temperature of about 25° C. and a pressure of about 0.03 bar. Then the cooling cycle is closed by passing the cooling medium through a heat exchanger 20 where it is cooled and condensed to state where is has a temperature of about 20° C. and a pressure of about 0.03 bar.

Assuming a feeding rate of 1 kg/s of methane gas and assuming a polytrophic energy efficiency of the multi stage turbines including electric generator of 90%, a remaining water content in the exhaust gas after condensation is 0.4%, this example embodiment of the invention will produce about 17 kW/h electric energy in the primary generator 8 and about 9 kW/h electric energy in the secondary generator 21. The process will produce about 2.25 kg/s water and about 2.75 kg/s CO₂.

### Example Embodiment 2

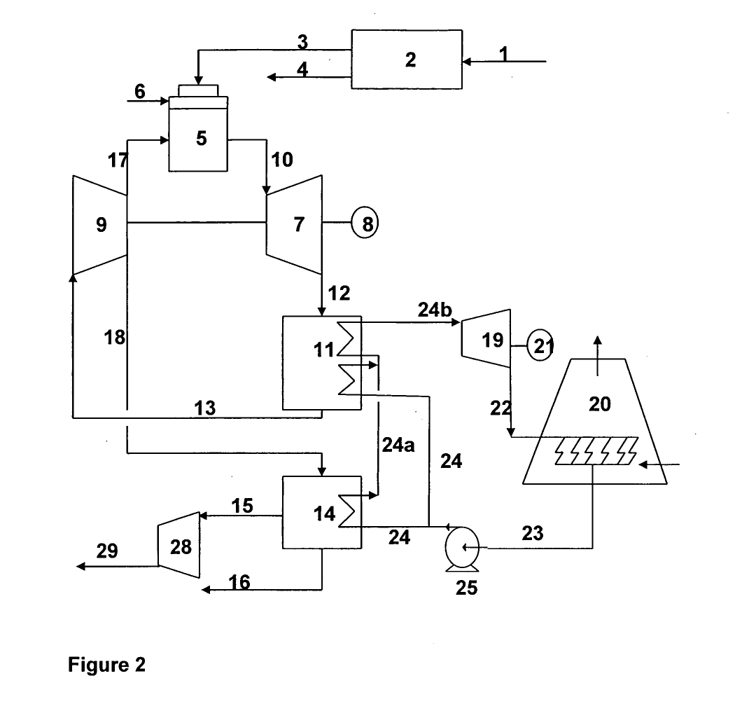

This example embodiment is designed for use in cases where cooling water is not present. Then the regeneration of the cooling medium may be obtained by use of a cooling tower, such that the cooling medium is cooled to about 30° C. by passing in counter flow of a passing air stream in the cooling tower instead of heat exchanger 20 with cooling water inlet 26 and outlet 27. Otherwise the example embodiment 2 is equal to example embodiment 1, and is schematically given in FIG. 2.

This example embodiment of the invention is suited for use in dry areas with access to natural gas, and may considerably alleviate the strain on fresh water supply in many regions in that it does not require water as cooling liquid, but also in that it produces water. For instance, a typical plant of 250 MW produced electricity is typically fed with about 10 kg natural gas per second, which will give a water production of about 22.5 kg water per second, which is sufficiently pure to be upgraded to drinking water quality by use of ordinary municipal water treatment processes.

### Example Embodiment 3

This example embodiment is optimised for use in offshore oil, and gas installations require heating, electric energy and fresh water for processing of the oil and gas and for sustaining the workforce on board. Offshore installations will normally have installed several cleaning systems for the fresh water used on board, which readily may upgrade water formed by the process according to the invention. This example embodiment is very suited for use on board these installations since the present invention may make offshore installations self sufficient with energy and fresh water. In addition the residual air fraction 4 may be exploited as pressure support in the reservoir by being deposited in the earth formation together with the CO₂. In this embodiment, the invention will have access to sea water as cooling liquid.

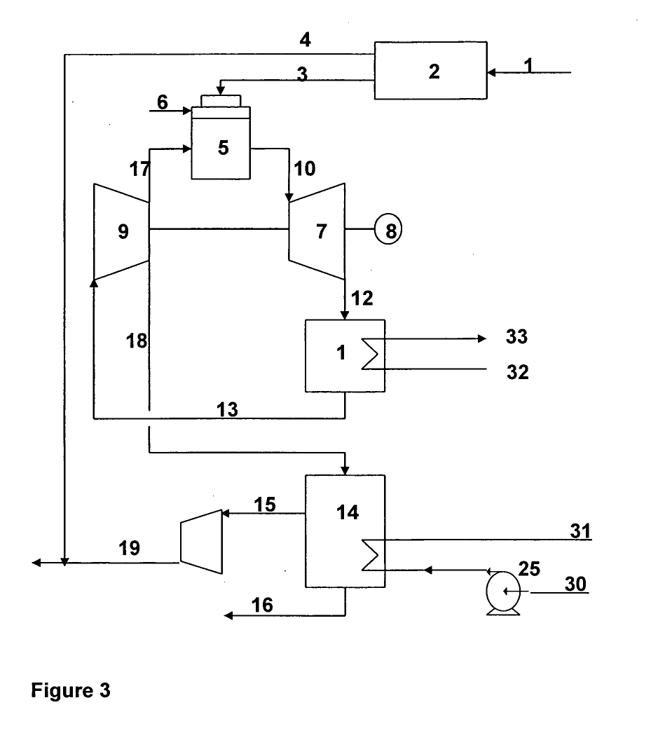

Example embodiment 3 is similar to example embodiment 1 except that the cooling of the exhaust gas condenser 14 and exhaust gas cooler 11 are obtain by separate cooling circuits. The example embodiment is schematically given in FIG. 3.

The cooling of the exhaust gas condenser 14 is obtained by use of heat exchanging with sea water in a separate cooling circuit where sea water is extracted from the sea by use of pump 25 and sent through the heat exchanger in the exhaust gas condenser 14 and then re-injected into the ocean by pipeline 31.

The cooling of the exhaust gas cooler 11 is obtained by extracting relatively cold water from the hot liquid system on-board the offshore installation through pipeline 32, passing the water through the heat exchanger(s) in the exhaust gas cooler 11, and passing heated water to the hot liquid system by pipeline 33. In this embodiment, the exergy of the cooling liquid is thus used for providing hot water to the offshore installation instead for producing electric energy.

Another difference from the example embodiments 1 and 2 is that the pipeline 4 for residual air (mainly nitrogen) from air separation unit 2 is connected to compressor 28 for use of the inert gas as pressure enhancer in the oil/gas-reservoir. One kilogram methane requires about 4 kg O₂ when combusted in a stochiometric ratio, and produces about 2.75 kg CO₂. The air separation unit produces about 3.3 kg residual air for each kg oxygen, such that the total amount of inert gas (residual air and CO₂) which may be inserted into the reservoir for each kg methane combusted becomes about 15.9 kg. Assuming equal temperature and pressure of extracted methane and the injected inert gas, and that the ideal gas law is valid, each volume unit of methane being withdrawn from the reservoir may be produce around 9 volumes units of inert gas.

### Example Embodiment 4

This example embodiment includes use of an intercooler in the compressor 9 for partial condensation of the water content of the exhaust gas. In this case the compressor 9 is divided into two compression steps with the intercooler and condenser in-between the first and second compression stage. This example embodiment obtains a reduction in the total work compression due to reduced mass flow in the downstream compressors. In addition, it opens the possibility of adjusting the CO₂/H₂O-ratio of the gas being recycled into the combustor, and thus the working medium for the whole primary power process.

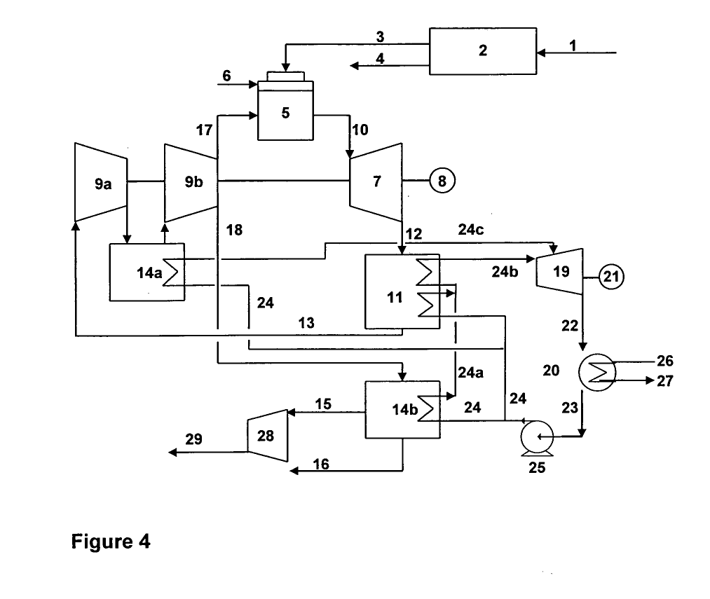

This example embodiment is schematically given in FIG. 4. In this embodiment the compressor 9 is divided into two stages 9a and 9b with condenser 14a placed in-between. The condensate is taken out in stream 16a (not shown in the Figure). The condenser is cooled by cooling medium at about 20° C. taken from pipeline 24, and the cooling medium is heated to about 100° C. in the condenser 14b and then passed to expander 19.

Rotary machinery like gas turbine trains normally takes significant amounts of time and resources to develop. It can therefore be very costly to develop these kind of equipment items for gas compositions that have properties very far from the currently applied gases (normally dominated by air). Though it can be an advantage to have the possibility to adjust the working medium in the process so it's properties are closer to conventionally applied gases. Then the extent of the development work can be reduced. The intercooler with condensation allows this process medium adjustment.

The pressure level in the intercooler 14a is largely decided by the pressure in the recycle exhaust stream 13. 1 bar pressure in stream 13 will typically give around 6 bar pressure as an optimum in the intercooler 14a, while an elevated pressure to e.g. 2 bar will give higher pressure as an optimum in the intercooler. Which pressure levels that are should be applied is an optimisation issue in each case.

1. A method for combined production of water and electric energy,
wherein the method comprises:
feeding substantially pure oxygen and a hydrocarbon fuel in a stochiometric ratio to a combustor,
combusting the oxygen and hydrocarbon feed for forming an exhaust gas at comparatively high temperature and pressure,
passing the exhaust gas at the comparatively high temperature and pressure to an expander that runs an electric generator and an exhaust gas compressor,
passing the exhaust gas exiting the expander to an exhaust gas cooler which cools the gas to a temperature above the steam condensation temperature,
passing the exhaust gas exiting the exhaust gas cooler to the exhaust gas compressor for pressurising, and
passing the pressurised exhaust gas to an exhaust gas condenser where the exhaust gas is condensed and thus separated into a substantially pure water fraction and a gaseous CO₂-fraction.

2. Method according to claim 1,
wherein the method also comprises
using a closed cooling liquid circuit for cooling the exhaust gas cooler and exhaust gas condenser, and
converting the exergy of the cooling liquid to electric energy by passing the heated cooling liquid exiting the exhaust gas cooler through an expander running an electric generator.

3. Method according to claim 1 or 2,
wherein the exhaust gas compressor includes a gas condenser for partial condensation of the water of the exhaust gas.

4. Method according to any of the preceding claims,
wherein the combustion process is regulated by passing a part stream from the exhaust gas compressor to the combustor.

5. Method according to any of the preceding claims,
wherein the oxygen supply is substantially pure oxygen from an air separation unit.

6. Plant for combined production of water and electric energy, wherein the plant comprises:
a source 3 for pure oxygen,
a source 6 for a hydrocarbon fuel,
a combustor 5 being fed with the pure oxygen and the hydrocarbon fuel,
an expander 7 running an electric generator 8 and a gas compressor 9,
means 10 for passing the exhaust gas exiting the combustor 5 to the expander 7,
an exhaust gas cooler 11,
means 12 for passing the exhaust gas exiting the expander 7 to the exhaust gas cooler 11,
means 13 for transporting the exhaust gas exiting the exhaust gas cooler 11 to the compressor 9,
an exhaust gas condenser 14,
means 18 for passing the pressurised exhaust gas exiting the compressor 9 to the exhaust gas condenser 14,
means 24 for supplying a cooling medium to the exhaust gas condenser 14 and the exhaust gas cooler 11, and
means 15, 16 for separate retrieval of the gaseous CO₂-fraction and the water fraction from the exhaust gas condenser, respectively.

7. Plant according to claim 6,
wherein the plant also includes a closed cooling liquid circuit for cooling the exhaust gas cooler 11 and exhaust gas condenser 14, where the cooling circuit comprises:
a pump 25,
means 24 for passing relatively cold cooling medium to a heat exchanger in the exhaust gas condenser 14 and a first heat exchanger in the exhaust gas cooler 11,
means 24a for passing moderately heated cooling liquid exiting the heat exchanger in the exhaust gas condenser 14 and the first heat exchanger in the exhaust gas cooler 11 to a second heat exchanger in the exhaust gas cooler 11,
means 24b for passing relatively highly heated cooling medium exiting the second heat exchanger in the exhaust gas cooler 11 to an expander 19 running an electric generator 21,
means 22 for passing cooling liquid exiting the expander 19 to a heat exchanger 20,
means 26, 27 for passing an second cooling medium from a heat sink to the heat exchanger 20, and
means 23 for closing the cooling liquid circuit by passing cooled cooling medium to pump 25.

8. Plant according to claim 7,
wherein the heat exchanger 20 and means 26, 27 are substituted by a cooling tower exploiting an air flow as heat sink.

9. Plant according to claim 6,
wherein
the exhaust gas condenser 14 is cooled by extracting cooling water from a heat sink by pump 25 and line 30, 31 and passing the cooling water through a heat exchanger in the exhaust gas condenser 14, and
the exhaust gas cooler 11 is cooled independently of exhaust gas condenser 14 by passing a second cooling medium through one or more heat exchangers in the exhaust gas cooler 11 through line 32, 33.

10. Plant according to claim 6,
wherein
the compressor 9 is divided into two compressors 9a and 9b and where a condenser 14b is placed in-between compressors 9a and 9b, and
the condensate is extracted through stream 16a, and
where the cooling of the condenser 14b is obtained by passing cooling medium from line 24 through a heat exchanger in the condenser 14b and passing heated cooling medium through line 24c to expander 19.

11. Plant according to any of claims 6-10,
wherein it also comprises means 17 for passing of the exhaust gas from the exhaust gas compressor 9 or 9b to the combustor 5.
